(19) United States
(12) Patent Application Publication
(10) Pub. No.: US 2019/0243481 A1
(43) Pub. Date: Aug. 8, 2019

(54) Electronic Device And Method Of Controlling The Same

(71) Applicants: BOE Technology Group Co., Ltd., Beijing (CN); HEFEI XINSHENG OPTOELECTRONICS TECHNOLOGY CO., LTD., Anhui (CN)

(72) Inventors: Jian Tian, Beijing (CN); Zouming Xu, Beijing (CN); Qitao Zheng, Beijing (CN); Chunjian Liu, Beijing (CN); Lei Zhang, Beijing (CN); Shuncheng Zhu, Beijing (CN); Tsung Chieh Kuo, Beijing (CN); Xiaodong Xie, Beijing (CN); Long He, Beijing (CN)

(73) Assignees: BOE Technology Group Co., Ltd., Beijing (CN); HEFEI XINSHENG OPTOELECTRONICS TECHNOLOGY CO., LTD., Anhui (CN)

(21) Appl. No.: 16/056,736

(22) Filed: Aug. 7, 2018

(30) Foreign Application Priority Data
Feb. 2, 2018 (CN) 201810107087.0

(51) Int. Cl. G06F 3/044

(52) U.S. Cl. CPC G06F 3/044; G06F 2203/04108

(57) ABSTRACT

In one embodiment, an electronic device includes: a frame; a plurality of conductive electrodes provided on the frame; and a processor electrically connected to the plurality of conductive electrodes, respectively. The processor is configured for charging the plurality of conductive electrodes, and is configured for respectively determining, according to charge quantities detected from the plurality of conductive electrodes, relative positions between a conductor that is close to the electronic device and the plurality of conductive electrodes at any time.

### CROSS-REFERENCE TO RELATED APPLICATION

This application claims priority to Chinese Patent Application No. 201810107087.0 filed on Feb. 2, 2018 in the state Intellectual Property Office of China, the disclosure of which is hereby incorporated by reference in its entirety.

### TECHNICAL FIELD

The present disclosure relates to the field of electronic device technology, and particularly, to an electronic device and a method of controlling the same.

### BACKGROUND

With the rapid development of electronic technology, a variety of electronic products are increasingly being used by people in a variety of situations. For example, when driving a vehicle, people uses a vehicle touch display to navigate, play music, play video, and the like.

Electronic product usually has a touch screen. The touch screen is generally classified into a capacitive touch screen or a resistive touch screen. When a user performs a control operation on the electronic product, a contact touching or pressing on the touch screen is required to achieve control of the electronic product.

However, the above contact manner of control is relatively single and inflexible.

### SUMMARY

According to an aspect of the present disclosure, there is provided an electronic device comprising: a frame; a plurality of conductive electrodes provided on the frame; and a processor electrically connected to the plurality of conductive electrodes, respectively, configured for charging the plurality of conductive electrodes, and configured for respectively determining, according to charge quantities detected from the plurality of conductive electrodes, relative positions between a conductor that is close to the electronic device and the plurality of conductive electrodes at any time.

In one embodiment, each edge of the frame is provided with at least one of the plurality of conductive electrodes.

In one embodiment, the electronic device further comprises: a connection line having one end connected to the processor and the other end configured for connection to an external device, to send the relative positions between the conductor and the plurality of conductive electrodes, determined by the processor, to the external device.

In one embodiment, the frame is configured for receiving the external device therein.

In one embodiment, the electronic device further comprises: a touch screen disposed within the frame.

In one embodiment, the plurality of conductive electrodes are arranged at a same surface of the frame.

According to another aspect of the present disclosure, there is provided a method of controlling an electronic device, and the method comprises:

determining instant working states and instant charge quantities of a plurality of conductive electrodes provided on a frame of the electronic device at current time;

determining, according to a correspondence between a working state and a charge quantity, a plurality of original charge quantities corresponding to the instant working states of the plurality of conductive electrodes; and

determining, according to the instant charge quantities and the original charge quantities of the plurality of conductive electrodes, relative positions between a conductor that is close to the electronic device and the plurality of conductive electrodes at the current time.

In one embodiment, after the step of determining relative positions between a conductor that is close to the electronic device and the plurality of conductive electrodes at the current time, the method further comprises:

determining, according to the relative positions between the conductor and the plurality of conductive electrodes within a continuous time period, an instant movement trajectory of the conductor;

determining, according to a correspondence between a movement trajectory and a target controlling mode, an instant target controlling mode corresponding to the instant movement trajectory; and

controlling the electronic device in accordance with the instant target controlling mode.

In one embodiment, the electronic device comprises N conductive electrodes, in which the N is a positive integer greater than one;

wherein, before the step of determining a plurality of original charge quantities corresponding to the instant working states of the plurality of conductive electrodes, the method further comprises:

detecting instant charge quantities of the N conductive electrodes, respectively, while charging an i^{th} one of the conductive electrodes and, in which the i^{th} is a positive integer equals to or less than N;

determining, according to a detection result, instant charge quantities of the N conductive electrodes when the one of the conductive electrodes is in a charging state and the rest ones of the conductive electrodes are in an induction state.

In one embodiment, the electronic device comprises a touch screen;

wherein, before the step of determining the relative positions between a conductor that is close to the electronic device and the plurality of conductive electrodes at the current time, the method further comprises:

determining, according to the relative positions between the conductor and the plurality of conductive electrodes, a target detection area of the touch screen;

detecting the target detection area of the touch screen, to determine an instant operating position where a user operates.

In one embodiment, the electronic device is in communication with an external device;

wherein, after the step of determining the relative positions between a conductor that is close to the electronic device and the plurality of conductive electrodes at the current time, the method further comprises:

sending the relative positions between the conductor and the plurality of conductive electrodes at the current time to the external device.

According to yet another aspect of the present disclosure, there is provided an electronic device comprising: a frame; a plurality of conductive electrodes provided on the frame; and a processor electrically connected to the plurality of conductive electrodes, respectively, and configured for executing the method of controlling an electronic device of any of the abovementioned embodiment.

### BRIEF DESCRIPTION OF THE DRAWINGS

The above and/or additional aspects and advantages of the present disclosure will become apparent and readily understood from the following description in conjunction with the attached drawings, in which:

FIG. 1 is a schematic view showing a structure of an electronic device according to an embodiment of the present disclosure;

FIG. 2 is a schematic view showing induction of charge quantity between a plurality of conductive electrodes in the electronic device according to the embodiment of the present disclosure;

FIG. 3 is a schematic view showing the structure of the electronic device according to the embodiment of the present disclosure, in which a conductor presents between the conductive electrodes;

FIG. 4 is a schematic view showing a structure of an electronic device according to another embodiment of the present disclosure;

FIG. 5 is a schematic view showing a structure of an electronic device according to yet another embodiment of the present disclosure;

FIG. 6 is a schematic view showing that at least one conductive electrode is provided at each edge of a touch screen, according to an embodiment of the present disclosure;

FIG. 7 is a schematic view showing that, a touch screen determines a position of a conductor in accordance with charge quantities induced by a plurality of conductive electrodes, according to an embodiment of the present disclosure;

FIG. 8 is a schematic view showing that, a touch screen determines a position of a conductor in accordance with charge quantities induced by a plurality of conductive electrodes within a continuous time period, according to an embodiment of the present disclosure;

FIG. 9 is a schematic view of determining a movement trajectory of a conductor above the touch screen, according to an embodiment of the present disclosure;

FIG. 10 is a schematic flow diagram showing a method of controlling an electronic device, according to an embodiment of the present disclosure;

FIG. 11 is a schematic flow diagram showing a method of controlling an electronic device, according to another embodiment of the present disclosure;

FIG. 12 is a schematic flow diagram of determining instant working states and instant charge quantities of a plurality of conductive electrodes provided on a frame of an electronic device at current time, according to an embodiment of the present disclosure;

FIG. 13 is a schematic block diagram of an electronic device according to an embodiment of the present disclosure.

### DETAILED DESCRIPTION OF THE EMBODIMENTS

The embodiments of the present disclosure will be described in detail hereinafter, and examples of the embodiments are illustrated in the drawings, wherein the same or similar reference numerals are used to refer to the same or similar elements or elements having the same or similar functions. The embodiments described hereinafter with reference to the accompanying drawings are exemplary, are intended to explain the present disclosure, and are not to be construed as limiting the present disclosure.

The present disclosure provides an electronic device. The electronic device comprises: a frame; a plurality of conductive electrodes provided on the frame; and a processor electrically connected to the plurality of conductive electrodes, respectively, configured for charging the plurality of conductive electrodes and detecting charge quantities of the plurality of conductive electrodes, and configured for respectively determining, according to charge quantities detected from the plurality of conductive electrodes, relative positions between a conductor that is close to the electronic device and the plurality of conductive electrodes at any time. Therefore, a floating touch detection is realized according to a change of the charge quantities induced by the conductive electrodes provided on the frame, thereby not only increasing flexibility and diversity of controlling the electronic device, but also improving user experience.

An electronic device and method of controlling the same according to the embodiments of the present disclosure are described below with reference to the accompanying drawings.

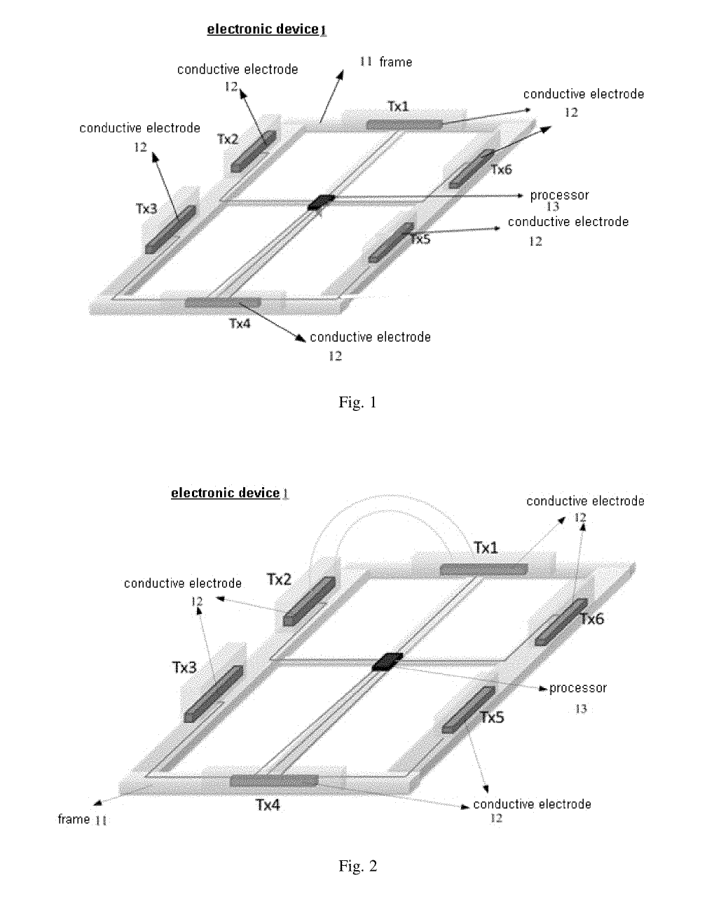

First of all, the electronic device according to the embodiment of the present disclosure will be specifically described with reference to FIG. 1.

FIG. 1 is a schematic view showing a structure of an electronic device according to an embodiment of the present disclosure.

Referring to FIG. 1, the electronic device comprises: a frame 11, a plurality of conductive electrodes 12 provided on the frame 13, and a processor 13.

The processor 13 is electrically connected to the plurality of conductive electrodes 12, respectively, is configured for charging the plurality of conductive electrodes 12, and is configured for respectively determining, according to charge quantities detected from the plurality of conductive electrodes 12, relative positions between a conductor 17 that is close to the electronic device 1 and the plurality of conductive electrodes 12 at any time.

In a specific implementation, the processor 13 of the electronic device 1 according to the present disclosure performs sequentially charging operations on the plurality of conductive electrodes 12 provided on the frame 11, and detects instant charge quantities of all the conductive electrodes 12 including the being-charged conductive electrodes 12 in real time. Then, the instant charge quantity of respective conductive electrode 12 is compared with its original charge quantity, and if the instant charge quantity of the respective conductive electrode 12 does not match its original charge quantity, it indicates that there is a conductor 17, which is close to the electronic device 1, at the current time. After that, based on the charge quantity mismatch, the electronic device 1 can determine relative positions between the conductor 17 and the plurality of the conductive electrodes 12. Therefore, the floating (non-contact) touch detection of the electronic device 1 is realized according to the change of the charge quantities induced by the conductive electrodes, thereby increasing flexibility and diversity of controlling the electronic device 1.

In the embodiments of the present disclosure, the conductive electrode may be self-capacitance and mutual-capacitance electrode, and thus can be used as both a driving electrode and a sensing electrode. The “initial charge quantity” described herein refers to the quantity of charges induced when the conductive electrode 12 is charged while no conductor 17 is close to the electronic device 1, and the “instant charge quantity” refers to the quantity of charges induced when the conductive electrode 12 is charged while a conductor 17 is close to the electronic device 1.

In the present embodiment, at least one conductive electrode 12 is provided on each edge of the frame 11 of the electronic device 1. When a respective conductive electrode 12 provided on each edge is charged, a capacitor is established between the respective conductive electrode 12 provided on the each edge and another conductive electrode 12 provided on other edge. A relative position between the conductor 17, that is close to the electronic device 1, and the respective conductive electrode 12 is determined according to change value of the charge quantity of this capacitor, thereby improving accuracy and reliability of determining the position of the conductor 17.

In the present embodiment, a plurality of conductive electrodes 12 are arranged at the same surface of the frame 11. In a specific implementation, if the charge quantity stored in each of the capacitors between the plurality of conductive electrodes 12 is particularly small, the detection whether the conductor 17 is close to the electronic device 1 or not is likely to be inaccurate. In order to improve the accuracy of the detection of the conductor 17, in this embodiment, the arrangement manner of the plurality of conductive electrodes 12 can be adjusted.

Specifically, in practical applications, charge quantity of a capacitor is affected by dielectric constant ε, plate area S, and distance d between polar plates. In the embodiments of the present disclosure, the conductive electrodes can be regarded as polar plates, the medium between any two polar plates is air, of which the dielectric constant is fixed, and the distance d between any two polar plates is also fixed, so the charge quantity of the capacitor is affected only by plate area S. Therefore, in the present disclosure, the plate area of each of the conductive electrodes 12 can be set suitably according to actual conditions, to improve accuracy and reliability of determining whether or not a conductor 17 is close to the electronic device 1.

In order to make the disclosure clearer, the above contents will be explained by way of examples hereinafter.

For example, as shown in FIG. 1, the frame 11 of the electronic device 1 has a rectangular shape, the number of the conductive electrodes 12 on each of the two long edges is two, and the number of the conductive electrodes 12 on each of the two short sides is one. The conductive electrodes 12 on the two long edges are respectively Tx2, Tx3, Tx5 and Tx6, and the conductive electrodes 12 on the two short edges are respectively Tx1 and Tx4. When the processor 13 performs charging operations sequentially on the plurality of edges of the frame 11 on the plurality of sides, each of the conductive electrodes 12, such as Tx1, Tx2, Tx3, Tx4, Tx5, and Tx6, provided on the frame 11 can induce the corresponding charge quantity, and the processor 13 can also acquire six sets of charge quantity induction information corresponding to the six conductive electrodes 12 provided on the frame 11.

The processor 13 of this embodiment charges the conductive electrodes 12 on each edge of the frame 11 and acquires charge quantity induction information of the plurality of conductive electrodes 12, as shown in FIG. 2. In FIG. 2, only an induction of the charge quantity between Tx1 and Tx2 is illustrated, however, inductions of the charge quantities between the rest ones of the conductive electrodes 12 are similar to that between Tx1 and Tx2, and will not be described herein.

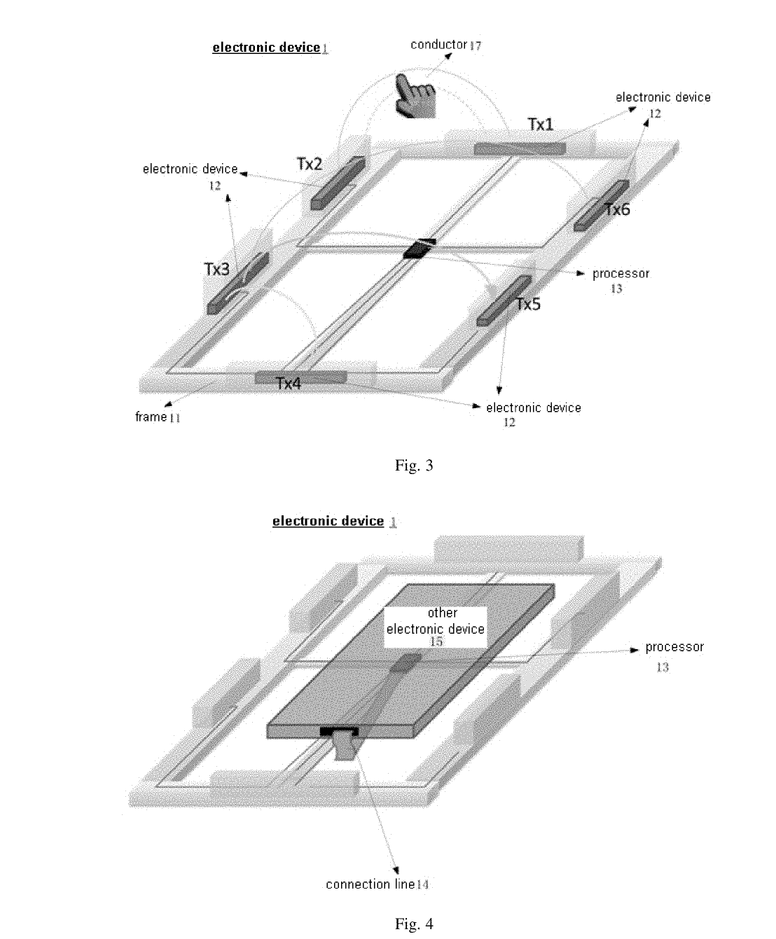

After the processor 13 acquires the above six sets of charge quantity induction information, it can compare the above six sets of induced charge quantities with respective original charge quantities. For example, the charge quantity induced by Tx2 decreases and the charge quantities induced by Tx3-Tx6 are substantially unchanged when Tx1 is charged, the charge quantities induced by Tx1 and Tx6 changes (in which the charge quantity induced by Tx1 is strongly affected while the charge quantity induced by Tx6 is weakly affected) while the charge quantities induced by Tx3-Tx5 are substantially unchanged when Tx2 is charged, the charge quantity induced by Tx1 is affected and the charge quantities induced by Tx2 and Tx4-Tx6 are substantially unchanged when Tx3 is charged, the charge quantity induced by Tx1 decreases and the charge quantities induced by Tx2-Tx3 and Tx5-Tx6 are substantially unchanged when Tx4 is charged, the charge quantity induced by Tx1-Tx4 and Tx6 are substantially unchanged when Tx5 is charged, and the charge quantity induced by Tx2 decreases and the charge quantities induced by Tx1 and Tx3-Tx5 are substantially unchanged when Tx6 is charged. Then, it is determined that there is a conductor 17 between the conductive electrodes Tx1 and Tx2, specifically as shown in FIG. 3. FIG. 3 is a schematic view showing there is a conductor 17 between the conductive electrodes Tx1 and Tx2.

Further, in the present embodiment, the processor 13 can not only determine relative positions between a conductor 17 that is close to the electronic device 1 and the plurality of conductor electrodes 12 according to the charge quantities induced by the plurality of conductive electrodes 12 on these edges of the frame 11, but also, according to charging operations performed sequentially on the conductive electrodes 12 in succession for a period of time, determine positional information of the conductor 17 at any time and thus acquire movement trajectory of the conductor 17 based on a plurality of discrete positional information abovementioned.

Moreover, after determining the relative position and the movement trajectory of the conductor 17, in the present embodiment, it can also send the determined relative positions and movement trajectory of the conductor 17 to an external device 15, so that the external device 15 can perform operations based on the relative positions and movement trajectory of the conductor 17, to achieve the floating control to the external device.

Specifically, as shown in FIG. 4, the electronic device 1 further includes: a connection line 14. One end of the connection line 14 is connected to the processor 13, and the other end is adapted to be connected to the external device external device 15 for sending the relative positions, determined by the processor 13, between the conductor 17 and the plurality of the conductive electrodes 12 to the external device 15, so that the external device 15 performs a floating control on the external device at the corresponding position according to the relative positions sent by the processor 13.

Further, in this embodiment, the processor 13 can also send the determined movement trajectory between the conductor 17 and the plurality of the conductive electrodes 12 to the external device 15, so that the external device 15 performs corresponding operations according to the movement trajectory of the conductor 17, thereby enabling the floating control of the external device. Of course, in this embodiment, the processor 13 can also send both the determined relative positions and the movement trajectory between the conductor 17 and the plurality of the conductive electrodes 12 to the external device 15, so that the external device 15 performs corresponding operations according to the relative positions and the movement trajectory of the conductor 17, thereby enabling the floating control of the external device.

It should be noted that, the “external device” described in the present disclosure refers to any other electronic devices that communicate and/or electrically connect with the electronic device 1 according to the embodiments of the present disclosure, for example, an electronic device having a capacitive touch screen or a resistive touch screen. In this embodiment, the external device 15 may be, but not limited to, a smart phone, a personal digital assistant, a palm computer, a tablet computer, etc., which is not specifically limited in this embodiment.

That is to say, in this embodiment, the processor 13 is connected to the external device 15 through the connection line 14, so that the processor 13 can directly transmit information such as the determined relative positions between the conductor 17 and the plurality of the conductive electrodes 12 to the external device 15 through the connection line 14, so that the external device 15 can perform corresponding operational control according to the abovementioned relative positions and the like, thereby implementing a floating control on the external device and improving the user's control experience on the external device.

In addition, in the embodiments of the present disclosure, the frame 11 of the electronic device 1 can also be used to accommodate an external device 15 therein, as shown in FIG. 4. Specifically, in practical applications, since the external device 15 may have various sizes, including, for example, 5.0 inches, 5.5 inches, 5.5 inches, 6.0 inches, 9.0 inches, etc., in order to be adapt to the external device 15 of different sizes, in this embodiment, the frame 11 can be a movable clamping frame 11, or a frame 11 of other shapes, which is not specifically limited in this embodiment.

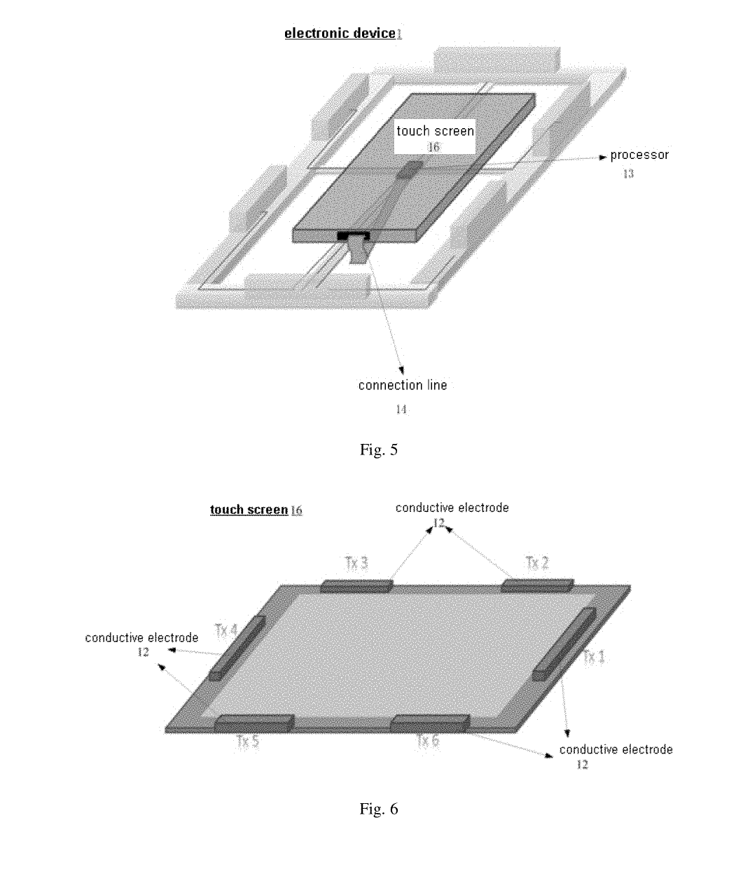

Further, as shown in FIG. 5, the electronic device 1 of the present disclosure may further comprise: a touch screen 16 disposed in the frame 11, to implement a touch control of the touch screen 16 in a manner of floating control.

In another embodiment of the present disclosure, in order to enable the user to implement the floating control on the electronic device 1 having a touch screen in the handheld mode, in the present embodiment, each edge of the touch screen 16 may be provided with at least one conductive electrode 12, and all the conductive electrodes 12 are electrically connected to the processor 13 of the electronic device 1, so that when the user operates the electronic device 1 in the handheld mode, the electronic device 1 can be operated not only by a touch manner, but also be controlled by a floating control manner, thereby increasing the control mode of the electronic device 1, and providing a basis for convenience of the user using the electronic device 1.

Hereinafter, referring to FIG. 6 to FIG. 9, each edge of the touch screen 16 is provided with at least one conductive electrode 12. A process of determining relative positions between the conductor 17 and the plurality of the conductive electrodes 12 of the electronic device 1 according to charge quantities induced by the plurality of conductive electrodes 12 at any time during charging of the plurality of the conductive electrodes 12 will be described in detail.

First of all, referring to FIG. 6, two long edges of the rectangular touch screen 16 are provided respectively with two conductive electrodes 12, that is, Tx2, Tx3, Tx5, and Tx6, and two short edges are respectively provided with one conductive electrode 12, that is, Tx1 and Tx4. It should be noted that, the manner and the number of the abovementioned conductive electrodes 12 provided on each edge of the touch screen 16 are merely exemplary and are not specifically limited to the present disclosure.

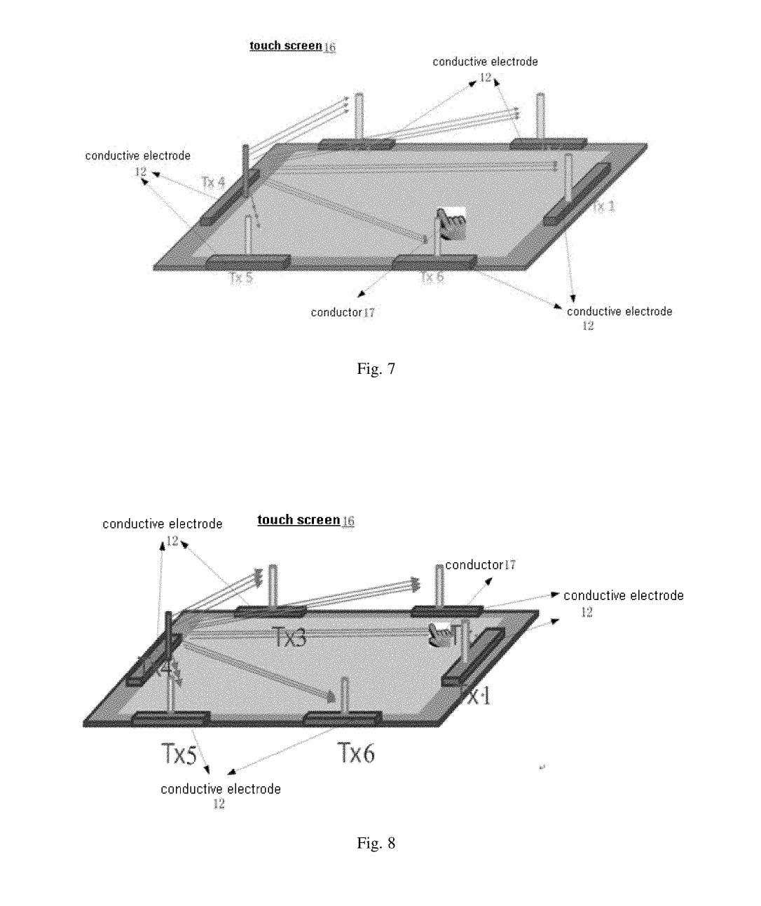

What's more, the six conductive electrodes 12 are sequentially charged by the processor 13, and correspondingly, six sets of induced charge quantities of the six conductive electrodes 12 are obtained. After the processor 13 obtains the six sets of induced charge quantities, it can compare the above six sets of induced charge quantities with respective original charge quantities. For example, the charge quantities induced by Tx2, Tx3, Tx4 are substantially unchanged, while the charge quantity induced by Tx5 decreases and the charge quantity induced by Tx6 decreases mostly when Tx1 is charged; the charge quantities induced by Tx1, Tx3, Tx4, Tx5 are substantially unchanged while the charge quantity induced by Tx6 changes greatly when Tx2 is charged; the charge quantities induced by Tx1, Tx2, Tx4, Tx5 are substantially unchanged while the charge quantity induced by Tx6 is changes greatly when Tx3 is charged; the charge quantities induced by Tx2, Tx3, Tx5 are substantially unchanged, the charge quantity induced by Tx6 is changed slightly while the charge quantity induced by Tx1 is changed greatly when Tx4 is charged; the charge quantities induced by Tx2-Tx4 are substantially unchanged, the charge quantity induced by Tx1 decreases while the charge quantity induced by Tx6 decreases slightly when Tx5 is charged; and the charge quantities induced by Tx3-Tx5 are generally unchanged, the charge quantity induced by Tx1 is small while the charge quantity induced by Tx2 is changed greatly when Tx6 is charged. After the analysis on the above six sets of data, it can be determined that the conductor 17 that is close to the electronic device 1 is located at the lower left corner shown in FIG. 7.

In addition, after determining the relative positions between the conductor 17 and the plurality of conductor electrodes 12, in order to determine the movement trajectory of the conductor 17, in this embodiment, the processor 13 may continuously perform in succession charging operations on the plurality of conductive electrodes 12 provided at the edges of the touch screen 16 for a period of time, to obtain six sets of induced charge quantities at different times to determine the movement trajectory of the conductor 17 on the touch screen 16 according to the six sets of induced charge quantities at different times.

In a specific implementation, for example, normal induced charge quantities are not obtained by Tx2, Tx3 (namely, normal induced charge quantities decrease) while the charge quantities induced by Tx4, Tx5, Tx6 are substantially unchanged when Tx1 is charged; the charge quantity induced by Tx1 is greatly changed (namely, greatly decreases), the charge quantities induced by Tx3, Tx4, Tx5 are substantially unchanged while the charge quantity induced by Tx6 decreases when Tx2 is charged; the charge quantities induced by Txl, Tx2 are changed due to presence of the conductor 17 while the charge quantities induced by Tx4, Tx5, Tx6 are substantially unchanged when Tx3 is charged; the charge quantities induced by Tx1, Tx2 are changed due to presence of the conductor 17 while the charge quantities induced by Tx3, Tx5, Tx6 are substantially unchanged when Tx4 is charged; the charge quantities induced by Tx1, Tx2 are changed due to presence of the conductor 17 while the charge quantity induced by Tx3, Tx4, Tx6 are substantially unchanged when Tx5 is charged; and the charge quantity induced by Tx2 is greatly changed while the charge quantities induced by Tx1, Tx3, Tx4, Tx5 are substantially unchanged when Tx6 is charged. From the above, it can be determined that the conductor 17 is located at the upper right corner shown in FIG. 8.

It should be noted that the above determination process is only a simplification one. In a practical determination process, due to high processing frequency of the processor, the processor can acquire a plurality of positional information of the conductor 17 at different positions of the touch screen when the conductor 17 is at these different positions of the touch screen, thereby achieving high accuracy and reliability of positional determination of the conductor 17.

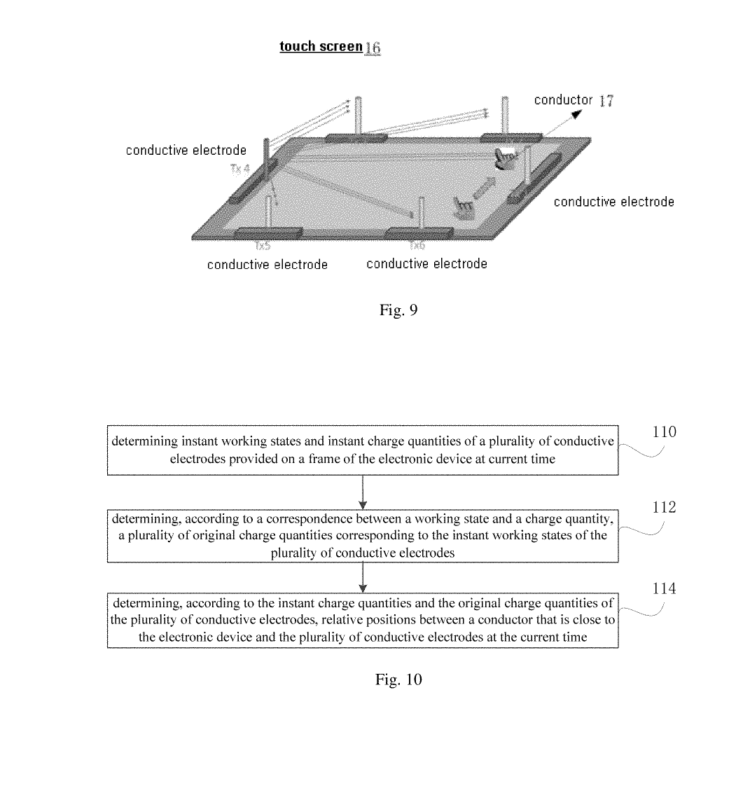

Finally, from the above analysis, it can be determined that an initial position of the conductor 17 is at the lower left corner of the touch screen 16, and an end position is at the upper right corner, and thus, it can be determined that the movement trajectory of the conductor 17 is from bottom to top, as shown in FIG. 9.

Furthermore, the processor 13 can perform corresponding controls on the electronic device 1 according to the determined relative positions between the conductor 17 and the plurality of the conductive electrodes 12 in the touch screen 16 as well as the movement trajectory of the conductor 17, thereby achieving a floating control of the electronic device 1 in a handheld mode.

The electronic device according to embodiments of the present disclosure comprises: a frame; a plurality of conductive electrodes provided on the frame; and a processor electrically connected to the plurality of conductive electrodes, respectively, configured for charging the plurality of conductive electrodes and detecting charge quantities of the plurality of conductive electrodes, and configured for respectively determining, according to charge quantities detected from the plurality of conductive electrodes, relative positions between a conductor that is close to the electronic device and the plurality of conductive electrodes at any time. Therefore, a floating touch detection is realized according to the change of the charge quantities induced by the conductive electrodes provided on the frame, thereby not only increasing flexibility and diversity of controlling the electronic device, but also improving user experience during using.

Based on the electronic device according to the above embodiments, it can be learned that a floating touch control is realized according to the change of the charge quantities induced by the conductive electrodes provided on the frame of the electronic device, thereby increasing flexibility and diversity of controlling the electronic device. A method of controlling the electronic device according to the embodiments of the present disclosure is described in detail hereinafter based on the electronic device according to any of the embodiments of the present disclosure.

Specifically, referring to FIG. 10, a method of controlling an electronic device may comprise the following steps.

A step 110 is to determine instant working states and instant charge quantities of a plurality of conductive electrodes provided on a frame of the electronic device at current time.

In the present embodiment, working states of the plurality of conductive electrodes may include charging state, inducing state and the like, which is not specifically limited herein.

In a specific implementation, the instant working states and the instant charge quantities of the plurality of the conductive electrodes can be determined by the processor in the electronic device, which is not specifically limited herein.

A step 112 is to determine, according to a correspondence between a working state and a charge quantity, a plurality of original charge quantities corresponding to the instant working states of the plurality of conductive electrodes.

Original charge quantity may be set suitably according to the actual situation, which is not specifically limited herein.

That is to say, when the conductive electrodes are in the charging state, original charge quantities of the conductive electrodes in the charging state may be determined; and when the conductive electrodes are in the inducing state, the original charge quantities of the conductive electrodes in the inducing state may be determined.

For example, if the working state of the conductive electrode A is an inducing state, original charge quantity of the conductive electrode A in the inducing state may be determined.

A step 114 is to determine, according to the instant charge quantities and the original charge quantities of the plurality of conductive electrodes, relative positions between a conductor that is close to the electronic device and the plurality of conductive electrodes at the current time.

Specifically, after determining the instant charge quantities and the original charge quantities of the plurality of conductive electrodes, in the present embodiment, the above instant charge quantities are brought to be compared with the original charge quantities. If the match is successful, it means that there is no conductor that is close to the electronic device at the current time; and if the match fails, it means that there is a conductor that is close to the electronic device at the current moment, and thus it need to determine relative positions between the conductor that is close to the electronic device and the plurality of conductive electrodes.

In a specific implementation, if the match fails, the failed match is analyzed to determine relative positions between the conductor that is close to the electronic device and the plurality of conductive electrodes. Therefore, a floating touch detection is realized according to the change of the charge quantities induced by the conductive electrodes 12, thereby increasing flexibility and diversity of controlling the electronic device 1.

The method of controlling an electronic device according to embodiments of the present disclosure comprises: determining instant working states and instant charge quantities of a plurality of conductive electrodes provided on a frame of the electronic device at current time; determining, according to a correspondence between a working state and a charge quantity, a plurality of original charge quantities corresponding to the instant working states of the plurality of conductive electrodes; and determining, according to the instant charge quantities and the original charge quantities of the plurality of conductive electrodes, relative positions between a conductor that is close to the electronic device and the plurality of conductive electrodes at the current time. Therefore, a floating touch detection is realized according to the change of the charge quantities induced by the conductive electrodes provided on the frame, thereby not only increasing flexibility and diversity of controlling the electronic device, but also improving user experience.

From the above, it can be learned that, the electronic device determines the relative positions between the conductor that is close to the electronic device and the plurality of conductive electrodes according to the instant charge quantities and the original charge quantities of the plurality of conductive electrodes. In order to enable the controlling to the electronic device more accurately according to the conductor that is close to the electronic device, in a specific implementation, relative positions between the conductor and the plurality of the conductive electrode at different times within a continuous time period can be obtained, and then a movement trajectory of the conductor is determined according to the these relative positions, so that the electronic device performs corresponding control according to the above movement trajectory. The method of controlling an electronic device in the above case will be specifically described below with reference to FIG. 11.

FIG. 11 is a schematic flow diagram showing a method of controlling an electronic device, according to another embodiment of the present disclosure.

Referring to FIG. 11, the method of controlling an electronic device may comprise the following steps.

A step 120 is to determine instant working states and instant charge quantities of a plurality of conductive electrodes provided on a frame of the electronic device at current time.

It should be noted that N conductive electrodes may be included in the electronic device according to the present disclosure, where N is a positive integer greater than 1.

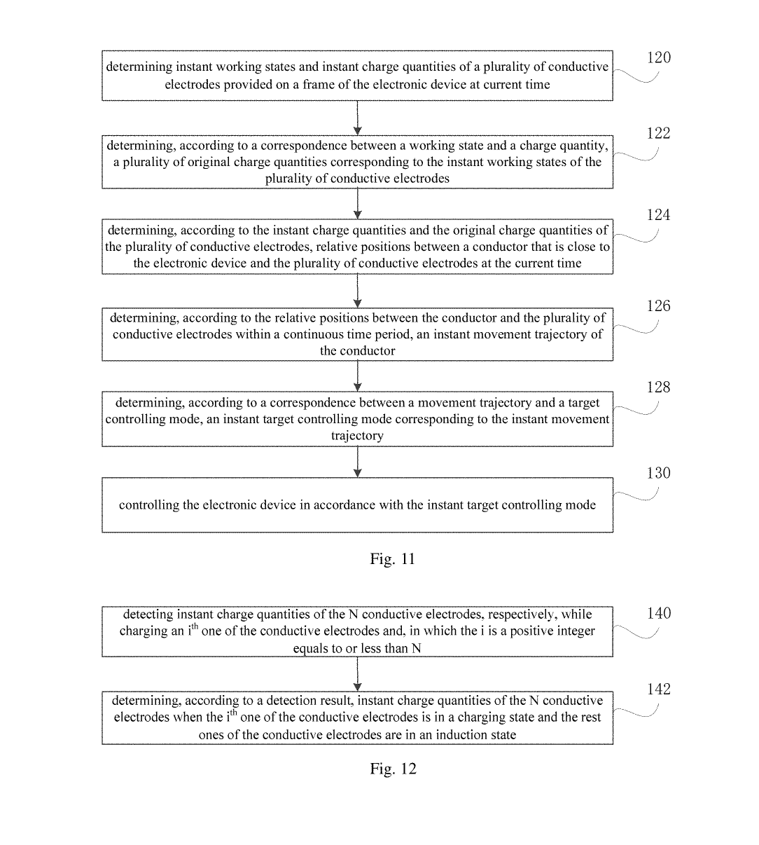

Therefore, according to the present disclosure, the step 120 of determining instant working states and instant charge quantities of a plurality of conductive electrodes can be further performed by the following steps, as shown in FIG. 12.

FIG. 12 is a schematic flow chart of determining instant working states and instant charge quantities of a plurality of conductive electrodes provided on a frame of the electronic device at current time.

A step 140 is to detect instant charge quantities of N conductive electrodes, respectively, while charging an one of the conductive electrodes and, in which the i is a positive integer equals to or less than N.

A step 142 is to determine, according to the detection result, instant charge quantities of the N conductive electrodes when the it one of the conductive electrodes is in a charging state and the rest ones of the conductive electrodes are in an induction state.

That is to say, in the present disclosure, the N conductive electrodes are sequentially charged to determine instant charge quantities of the plurality of conductive electrodes that are in the charging state as well as in the induction state.

A step 122 is to determine, according to a correspondence between a working state and a charge quantity, a plurality of original charge quantities corresponding to the instant working states of the plurality of conductive electrodes.

A step 124 is to determine, according to the instant charge quantities and the original charge quantities of the plurality of conductive electrodes, relative positions between a conductor that is close to the electronic device and the plurality of conductive electrodes at the current time.

Specific implementation processes and principles of these steps 122-124 may refer to the detailed description of the abovementioned embodiments, and are not described herein repeatedly.

A step 126 is to determine, according to the relative positions between the conductor and the plurality of conductive electrodes within a continuous time period, an instant movement trajectory of the conductor.

Specifically, in the present embodiment, a plurality of discrete relative positions between a conductor and the plurality of conductive electrodes within the continuous time period can be obtained. After analyzing the plurality of discrete relative positions, the movement trajectory of the conductor can be determined.

A step 128 is to determine, according to a correspondence between a movement trajectory and a target controlling mode, an instant target controlling mode corresponding to the instant movement trajectory.

A step 130 is to control the electronic device in accordance with the instant target controlling mode.

It should be noted that, the correspondence between the movement trajectory and the target controlling mode in the present embodiment may be established according to a large number of experiments, which is not specifically limited in this embodiment.

For example, if a movement trajectory of the conductor is running from the left to the right linearly, the electronic device can find a corresponding target controlling mode that matches the above movement trajectory based on the correspondence, and then control the electronic device according to the determined target controlling mode to perform a corresponding operation.

It should be noted that, in the present embodiment, the pre-established correspondence between the movement trajectory and the target controlling mode may be updated according to practical needs, so as to increase the control speed of the electronic device and thus improve the reflection capability of the electronic device.

In another embodiment of the present disclosure, the electronic device may further comprise a touch screen.

Accordingly, after the step 124, the method of controlling the electronic device may further comprise:

determining, according to the relative positions between the conductor and the plurality of conductive electrodes, a target detection area of the touch screen;

detecting the target detection area of the touch screen, to determine an instant operating position where a user operates.

Specifically, in the related art, the touch screen usually detects its entire area in real time in order to find the user's operating position, which not only affects the processing speed of the electronic device, but also causes waste of the charge quantity. In this regard, the present disclosure performs detection of target area on the touch screen. That is, based on the positional determination of a floating control operation, the detection area of the touch screen where an operation position performed by a user reduces, thereby improving a speed of the position detection on the screen touch, saving the processor's processing capacity and improving the user experience.

In another embodiment of the present disclosure, the electronic device may also be in communication with an external device to send the determined relative positions between the conductor that is close to the electronic device and the plurality of conductive electrodes at the current time to the external device, so that the external device can perform a corresponding operation and control based on the above relative positions, thereby realizing a floating control of the external device and improving the user experience on controlling the device.

The method of controlling an electronic device according to embodiments of the present disclosure comprises: determining instant working states and instant charge quantities of a plurality of conductive electrodes provided on a frame of the electronic device at current time; determining, according to a correspondence between a working state and a charge quantity, a plurality of original charge quantities corresponding to the instant working states of the plurality of conductive electrodes; determining, according to the instant charge quantities and the original charge quantities of the plurality of conductive electrodes, relative positions between a conductor that is close to the electronic device and the plurality of conductive electrodes at the current time; determining, according to the relative positions between the conductor and the plurality of conductive electrodes within a continuous time period, an instant movement trajectory of the conductor; determining, according to a correspondence between a movement trajectory and a target controlling mode, an instant target controlling mode corresponding to the instant movement trajectory; and controlling the electronic device in accordance with the instant target controlling mode. Therefore, a floating touch detection is realized according to the change of the charge quantities induced by the conductive electrodes provided on the frame, thereby not only increasing flexibility and diversity of controlling the electronic device, but also improving user experience. In addition, the electronic device can also be controlled according to the target controlling mode, which increases the control speed of the electronic device, improves the operational fluency of the device, and meet the user's needs.

In order to implement the method according to the above embodiments, the present disclosure also provides an electronic device.

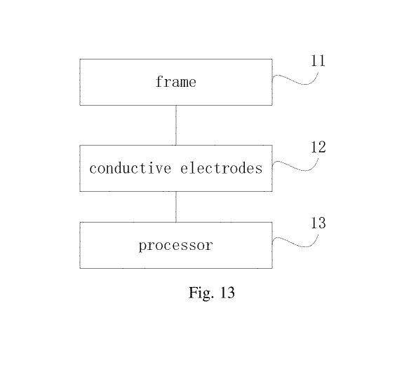

FIG. 13 is a schematic block diagram of an electronic device according to an embodiment of the present disclosure.

Referring to FIG. 13, the electronic device comprises: a frame 11; a plurality of conductive electrodes 12 provided on the frame 11; and a processor 13.

The processor is configured for executing the method of controlling an electronic device according to any one of the above embodiments.

The method of controlling an electronic device comprises: determining instant working states and instant charge quantities of a plurality of conductive electrodes provided on a frame of the electronic device at current time; determining, according to a correspondence between a working state and a charge quantity, a plurality of original charge quantities corresponding to the instant working states of the plurality of conductive electrodes; and determining, according to the instant charge quantities and the original charge quantities of the plurality of conductive electrodes, relative positions between a conductor that is close to the electronic device and the plurality of conductive electrodes at the current time.

It should be noted that, specific implementation processes and technical principles of the electronic device according to the present embodiment may refer to the detailed description of the method of controlling an electronic device according to the abovementioned embodiments, and are not described herein again.

In the description of the present specification, the description with reference to these terms “one embodiment”, “some embodiments”, “example”, “specific example”, or “some examples” and the like means that specific feature(s), structure(s), material(s) or characteristic(s) described in the embodiment or example is(are) included in at least one embodiment or example of the present disclosure.

Moreover, the terms “first” and “second” are used for descriptive purposes only and are not to be construed as indicating or implying a relative importance or implicitly indicating the number of technical features indicated. Thus, features defined with “first” or “second” may include at least one of the features, either explicitly or implicitly.

Any process or method described in the flowcharts or otherwise manner herein may be understood as one or more module, segment or portion of code representing executable instructions including steps for implementing a particular logical function or process. And the scope of these described embodiments of the present disclosure includes additional implementations in which the functions may be performed in a substantially simultaneous manner or in the reverse order depending on the functions involved, in the order shown or discussed. It will be understood by those skilled in the art to which the embodiments of the present disclosure pertain.

It should be understood that some portions of the present disclosure can be implemented in hardware, software, firmware, or a combination thereof. In the abovementioned embodiments, a plurality of steps or processes may be implemented in software or firmware stored in a memory and executed by a suitable instruction execution system. For example, if it is implemented in hardware, as in another embodiment, it can be implemented by any one or combination of the following techniques well known in the art: discrete logic circuits having logic gates for implementing logic functions on data signals, specific integrated circuits having suitable combinational logic gates, programmable gate arrays (PGAs), field programmable gate arrays (FPGAs), etc..

It can be understood by those skilled in the art that all or part of the steps of the method according to the above embodiments can be implemented can be completed through a program to instruct related hardware, and the program can be stored in a computer readable storage medium. When executed, the process includes one or a combination of the steps of the method according to the above embodiments. The storage medium mentioned above may be a read only memory, a magnetic disk or an optical disk or the like.

Although the disclosed embodiments of the present disclosure have been shown and described as above, the embodiments described are merely exemplary and are not intended to limit the present disclosure. Variations, modifications, alterations and variations of the above-described embodiments may be made by those skilled in the art within the scope of the present disclosure, the scope of which is defined in the attached claims.

What is claimed is:

1. An electronic device comprising:
a frame;
a plurality of conductive electrodes provided on the frame; and
a processor electrically connected to the plurality of conductive electrodes, respectively, configured for charging the plurality of conductive electrodes, and configured for respectively determining, according to charge quantities detected from the plurality of conductive electrodes, relative positions between a conductor that is close to the electronic device and the plurality of conductive electrodes at any time.

2. The electronic device of claim 1, wherein each edge of the frame is provided with at least one of the plurality of conductive electrodes.

3. The electronic device of claim 1, further comprising: a connection line having one end connected to the processor and the other end configured for connection to an external device, to send the relative positions between the conductor and the plurality of conductive electrodes, determined by the processor, to the external device.

4. The electronic device of claim 3, wherein the frame is configured for receiving the external device therein.

5. The electronic device of claim 1, further comprising: a touch screen disposed within the frame.

6. The electronic device of claim 1, wherein the plurality of conductive electrodes are arranged at a same surface of the frame.

7. A method of controlling an electronic device, the method comprising:
determining instant working states and instant charge quantities of a plurality of conductive electrodes provided on a frame of the electronic device at current time;
determining, according to a correspondence between a working state and a charge quantity, a plurality of original charge quantities corresponding to the instant working states of the plurality of conductive electrodes; and
determining, according to the instant charge quantities and the original charge quantities of the plurality of conductive electrodes, relative positions between a conductor that is close to the electronic device and the plurality of conductive electrodes at the current time.

8. The method of claim 7, after the step of determining relative positions between a conductor that is close to the electronic device and the plurality of conductive electrodes at the current time, further comprising:
determining, according to the relative positions between the conductor and the plurality of conductive electrodes within a continuous time period, an instant movement trajectory of the conductor;
determining, according to a correspondence between a movement trajectory and a target controlling mode, an instant target controlling mode corresponding to the instant movement trajectory; and
controlling the electronic device in accordance with the instant target controlling mode.

9. The method of claim 7, wherein the electronic device comprises N conductive electrodes, in which the N is a positive integer greater than one;
wherein, before the step of determining a plurality of original charge quantities corresponding to the instant working states of the plurality of conductive electrodes, the method further comprises:
detecting instant charge quantities of the N conductive electrodes, respectively, while charging an i^{th} one of the conductive electrodes and, in which the i is a positive integer equals to or less than N;
determining, according to a detection result, instant charge quantities of the N conductive electrodes when the i^{th} one of the conductive electrodes is in a charging state and the rest ones of the conductive electrodes are in an induction state.

10. The method of claim 7, wherein the electronic device comprises a touch screen;
wherein, before the step of determining the relative positions between a conductor that is close to the electronic device and the plurality of conductive electrodes at the current time, the method further comprises:
determining, according to the relative positions between the conductor and the plurality of conductive electrodes, a target detection area of the touch screen;
detecting the target detection area of the touch screen, to determine an instant operating position where a user operates.

11. The method of claim 7, wherein the electronic device is in communication with an external device;
wherein, after the step of determining the relative positions between a conductor that is close to the electronic device and the plurality of conductive electrodes at the current time, the method further comprises:
sending the relative positions between the conductor and the plurality of conductive electrodes at the current time to the external device.

12. An electronic device comprising:
a frame;
a plurality of conductive electrodes provided on the frame; and
a processor electrically connected to the plurality of conductive electrodes, respectively, and configured for executing the method of controlling an electronic device of claim 7.
